(19) United States
(12) Patent Application Publication
(10) Pub. No.: US 2009/0279898 A1
(43) Pub. Date: Nov. 12, 2009

(54) Bi-directional optical device for use in fiber-optic communications

(76) Inventors: Jin-Shan Pan, Hsinchu City (TW); Shang-Cheng Liu, Hsinchu County (TW); Cheng-Ju Wu, Hsinchu County (TW)

Correspondence Address: Raymond Sun, 12420 Woodhall Way, Tustin, CA, 92782, US

(21) Appl. No.: 12/387,797

(22) Filed: May 7, 2009

(30) Foreign Application Priority Data
May 8, 2008 (TW) 097117066

(51) Int. Cl. H04B 10/24

(52) U.S. Cl. 398/139

(57) ABSTRACT

A bi-directional optical device includes: a TO cap; a TO header defining a receiving space together with the TO cap; a laser chip provided on the TO header and in the receiving space; and a light-receiving chip provided on the TO header and in the receiving space. The TO cap has a cap body and a lens embeddedly mounted on the cap body. The laser chip emits a first laser beam toward the lens. The light-receiving chip faces the lens and receives a second laser beam transmitted through the lens. The laser chip and the light-receiving chip are packaged together within the receiving space defined by the TO cap and the TO header, so as to effectuate a bi-directional optical device for emitting and receiving light of different wavelengths.

### BACKGROUND OF INVENTION

1. Field of the Invention

The present invention relates to optoelectronic devices and, more particularly, to a bi-directional optical device for use in fiber-optic communications.

2. Description of the Prior Art

The Internet provides a convenient information exchange platform. Owing to ever-increasing demand for transmission of information such as audio data and video data, the maximum transmission speed of cable at a conventional user end has fallen short of the demand. This causes conventional cables to give way to the emerging application of optical fibers so as to provide users with more information transmission.

To further increase information transmitted by optical fibers, Wavelength Division Multiplex (WDM) technology is adopted for transmitting light beams of different wavelengths through an optical fiber simultaneously.

Conventional triple-wavelength bi-directional multiplex transmission requires a transmitter optical subassembly (TOSA) and a receiver optical subassembly (ROSA) operating in conjunction with the TOSA. The ROSA has one laser component and two light-receiving components independently packaged in TO-cans.

However, the ROSA is disadvantaged by intricate structure, a plethora of parts, and high assembly costs to the detriment of wide use of fiber-optic communications. Accordingly, manufacturers concerned consider it important to simplify the structure and lower the production cost of the ROSA.

### SUMMARY OF INVENTION

It is an objective of the present invention to provide a bi-directional optical device configured for use in fiber-optic communications so that a receiver optical subassembly (ROSA) equipped with the bi-directional optical device has a simple structure and low production cost.

To achieve the above and other objectives, the present invention provides a bi-directional optical device comprising: a TO cap; a TO header defining a receiving space together with the TO cap; a laser chip provided on the TO header and in the receiving space; and a light-receiving chip provided on the TO header and in the receiving space. The TO cap has a cap body and a lens embeddedly mounted on the cap body. The laser chip emits a first laser beam toward the lens. The light-receiving chip faces the lens and receives a second laser beam transmitted through the lens.

According to the present invention, the laser chip and the light-receiving chip are packaged together within the receiving space defined by the TO cap and the TO header of the bi-directional optical device, and thus the bi-directional optical device transmits and receives light beams of different wavelengths. Consequently, a ROSA equipped with the bi-directional optical device has a simple structure and low production cost.

### BRIEF DESCRIPTION OF THE DRAWINGS

The invention as well as a preferred mode of use, further objectives, and advantages thereof will be best understood by referring to the following detailed description of three preferred embodiments in conjunction with the accompanying drawings, wherein:

FIG. 1 is a schematic view of a bi-directional optical device for use in fiber-optic communications according to a first preferred embodiment of the present invention;

FIG. 2 is a cross-sectional view of the bi-directional optical device in FIG. 1;

FIG. 3 is a cross-sectional view of the bi-directional optical device in a second preferred embodiment of the present invention;

FIG. 4 is a cross-sectional view of another aspect of the bi-directional optical device in the second preferred embodiment of the present invention;

FIG. 5 is a cross-sectional view of yet another aspect of the bi-directional optical device in the second preferred embodiment of the present invention;

FIG. 6 is a cross-sectional view of the bi-directional optical device in a third preferred embodiment of the present invention;

FIG. 7 is a cross-sectional view of another aspect of the bi-directional optical device in the third preferred embodiment of the present invention;

FIG. 8 is a cross-sectional view of yet another aspect of the bi-directional optical device in the third preferred embodiment of the present invention; and

FIG. 9 is a cross-sectional view of a further aspect of the bi-directional optical device in the third preferred embodiment of the present invention.

### DETAILED DESCRIPTION OF PREFERRED EMBODIMENTS

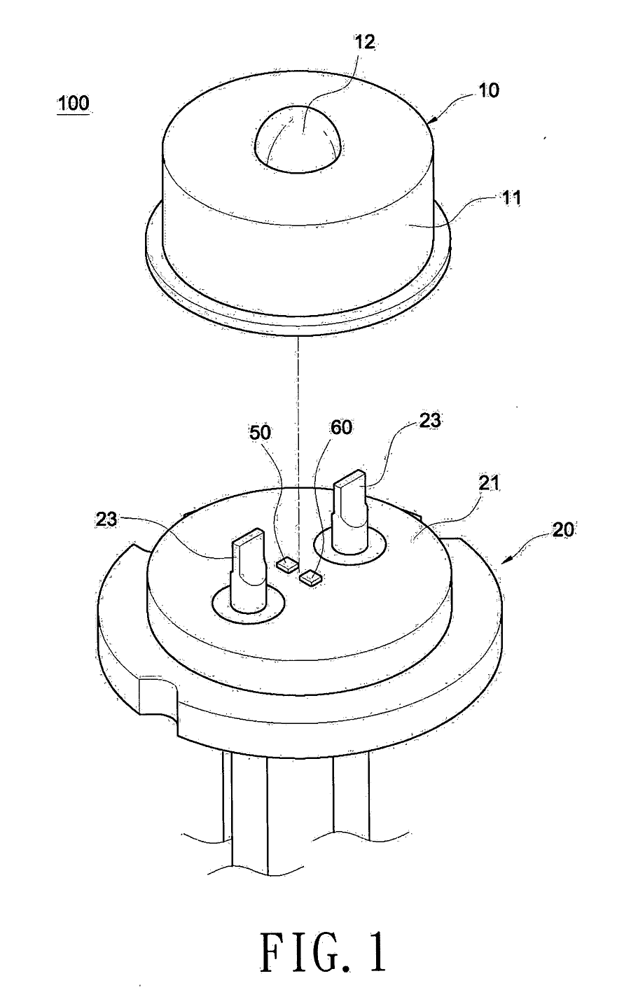

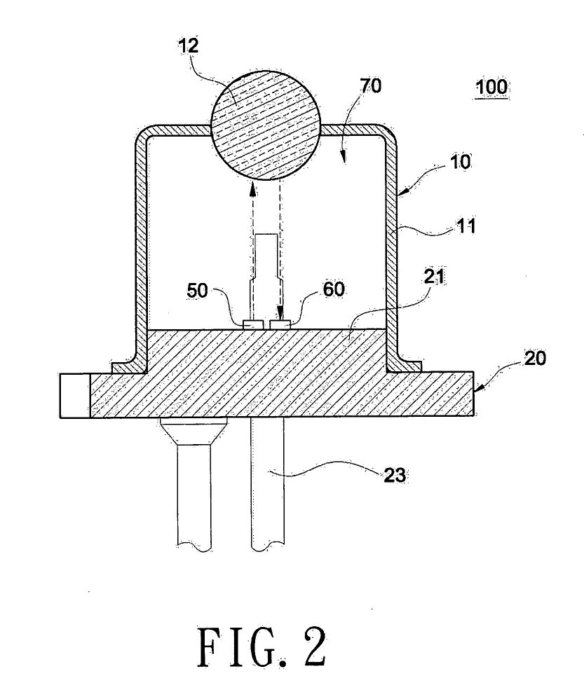

Referring to FIG. 1 and FIG. 2, a first preferred embodiment of a bi-directional optical device 100 for use in fiber-optic communications according to the present invention essentially comprises a TO cap 10, a TO header 20, a laser chip 50, and a light-receiving chip 60.

The TO cap 10 has a cap body 11 and a lens 12 embeddedly mounted on the cap body 11. In the first preferred embodiment, the lens 12 is a spherical lens. In practice, however, the shape of the lens is not limited to the spherical shape.

The TO header 20 is made of metal, and is provided with a bottom board 21 and a plurality of metal leads 23. The bottom board 21 and the TO cap 10 together define a receiving space 70 (see FIG. 2). The metal leads 23 penetrate the bottom board 21 and extend into the receiving space 70. The TO header 20 and the TO cap 10 together form a TO-can package. In the first preferred embodiment, the TO-can is selectively in the form of TO-46. In practice, in addition to TO-46, the TO-can can also be in the form of TO-56 or any other form of TO-cans. The laser chip 50 is a vertical cavity surface-emitting laser (VCSEL) made of a semiconductor material. In practice, the laser chip 50 can also be a horizontal cavity surface-emitting laser (HCSEL) or an edge-emitting laser made of a semiconductor material. The light-receiving chip 60 can be an APD (advanced photo diode) diode light-receiving chip, a PIN (p-intrinsic-n) diode light-receiving chip or a side-illumination photo diode chip made of a semiconductor material.

The laser chip 50 and the light-receiving chip 60 are positioned proximate to each other, provided directly on an upper surface of the bottom board 21 of the TO header 20, and located in the receiving space. The laser chip 50 emits a first laser beam toward the lens 12. The light-receiving chip 60 faces the lens 12 so as to receive a second laser beam transmitted through the lens 12.

In the first preferred embodiment, the wavelength of the first laser beam emitted by the laser chip 50 is 850 nm but is not limited thereto, and the wavelength of the second laser beam received by the light-receiving chip 60 is 1310 nm but is not limited thereto. In practice, the present invention is not limited by the aforesaid wavelengths, but the wavelength of the second laser beam received by the light-receiving chip 60 is definitely different from the wavelength of the first laser beam emitted by the laser chip 50.

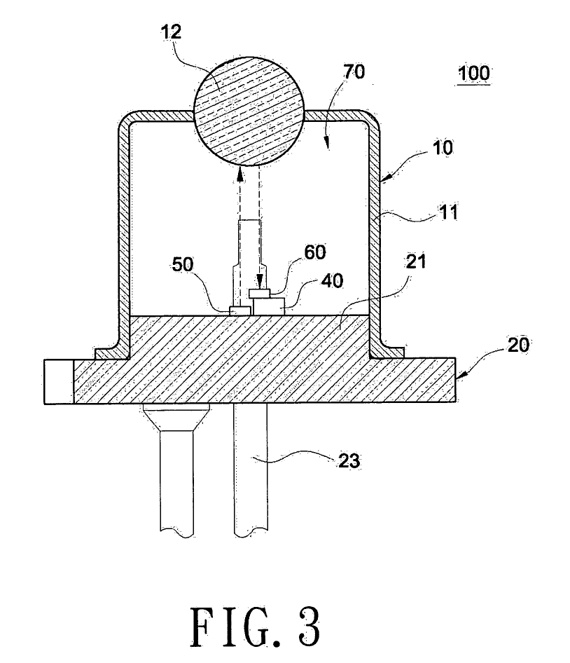

Referring to FIG. 3, a second preferred embodiment of the bi-directional optical device 100 for use in fiber-optic communications according to the present invention is slightly different from the first preferred embodiment in that the bi-directional optical device 100 in the second preferred embodiment further comprises a sub-mount 40 disposed between the bottom board 21 of the TO header 20 and the light-receiving chip 60.

The sub-mount 40 is disposed on the upper surface of the bottom board 21. In the second preferred embodiment, the sub-mount 40 is made of a silicon material (e.g., silicon wafer) but is not limited thereto. In practice, the sub-mount 40 can be made of an insulating material or an electrically conductive material.

The laser chip 50 is provided on the upper surface of the bottom board 21 and is positioned proximate to the sub-mount 40. The light-receiving chip 60 is provided on the sub-mount 40. The laser chip 50 emits a laser beam toward the lens 12. The light-receiving chip 60 faces the lens 12 and receives a light beam transmitted through the lens 12. In practice, it is also feasible to dispose the laser chip 50 on the sub-mount 40 and the light-receiving chip 60 on the upper surface of the bottom board 21.

Positioning the light-receiving chip 60 at a relatively great height by means of the sub-mount 40 allows the laser chip 50 and the light-receiving chip 60 to be positioned at different heights. Thus, the laser chip 50 overlaps the light-receiving chip 60 slightly along the direction of light emission, so as to allow the laser chip 50 to emit the laser beam in a direction relatively close to the incident direction of the light beam received by the light-receiving chip 60. In addition, the height of sub-mount 40 can be modified to suit the actually needs in order to adjust either an optic plane of focus or a distance between the light axes of two chips 50, 60.

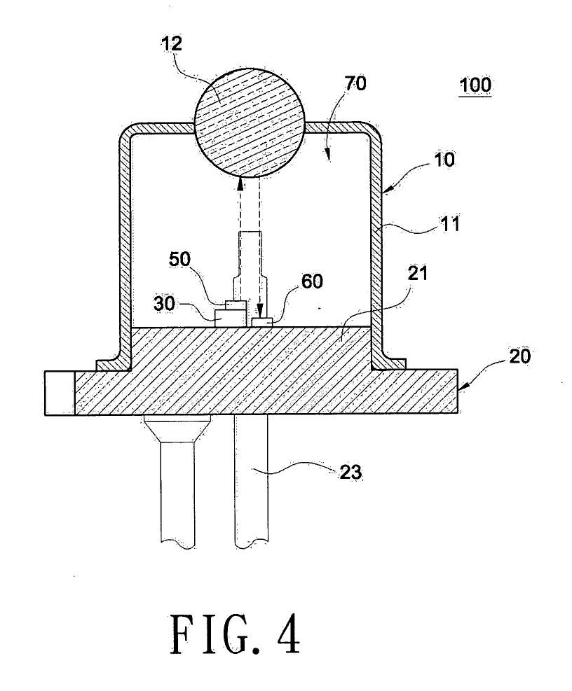

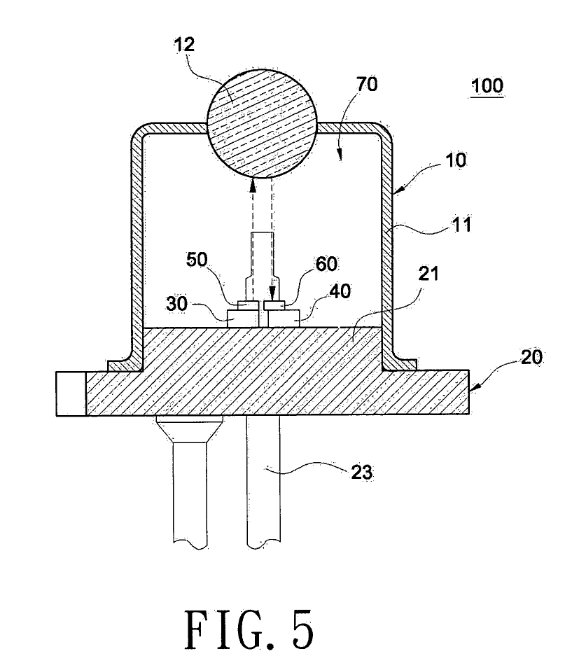

Referring to FIG. 4, alternatively, a sub-mount 30 is disposed between the bottom board 21 of the TO header 20 and the laser chip 50 so as to lift the laser chip 50. Referring to FIG. 5, alternatively, sub-mounts 30, 40 are disposed between the bottom board 21 of the TO header 20 and the laser chip 50 and disposed between the bottom board 21 of the TO header 20 and the light-receiving chip 60, respectively, thus allowing the sub-mounts 30, 40 to adjust the positions of the laser chip 50 and of the light-receiving chip 60 relative to the lens 12, respectively, so as to enable enhanced optical performance. The sub-mounts 30, 40 are made of an insulating material or an electrically conductive material.

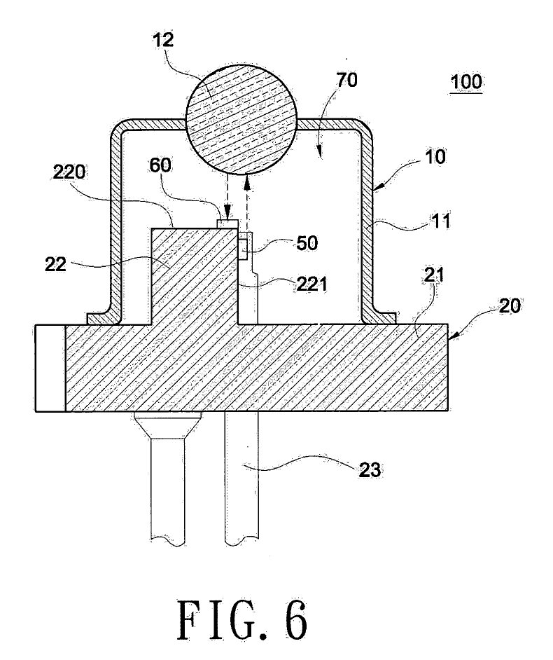

Referring to FIG. 6, a third preferred embodiment of the bi-directional optical device 100 for use in fiber-optic communications according to the present invention is slightly different from the first preferred embodiment in that the TO header 20 in the third preferred embodiment is further provided with a post 22 extending from the upper surface of the bottom board 21 into the receiving space 70. The post 22 has a top assembling surface 220 facing the lens 12 and a side assembling surface 221 perpendicular and adjacent to the top assembling surface 220.

The laser chip 50 is a side-emitting laser made of a semiconductor material. The laser chip 50 is mounted on the side assembling surface 221 of the post 22 and emits a laser beam toward the lens 12. The light-receiving chip 60 is mounted on the top assembling surface 220 of the post 22 and faces the lens 12 so as to receive a light beam transmitted through the lens 12.

Hence, in the third preferred embodiment, the side-emitting laser chip is mounted on the side assembling surface 221 of the post 22 of the TO header 20 so as to emit a laser beam toward the lens 12.

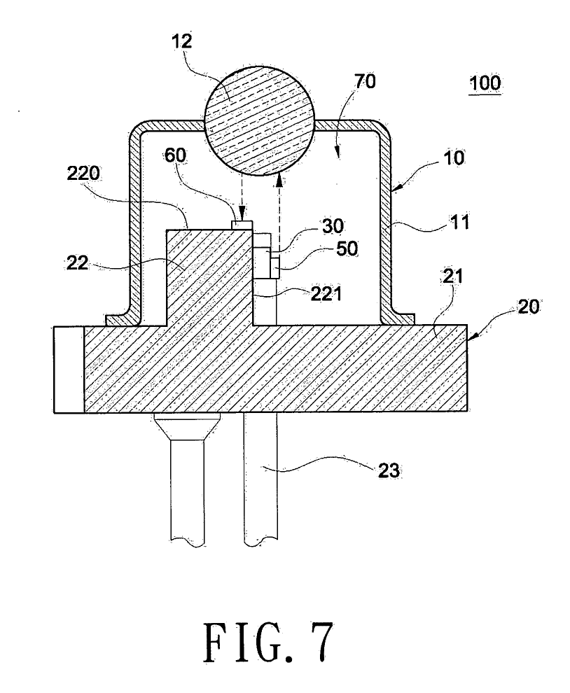

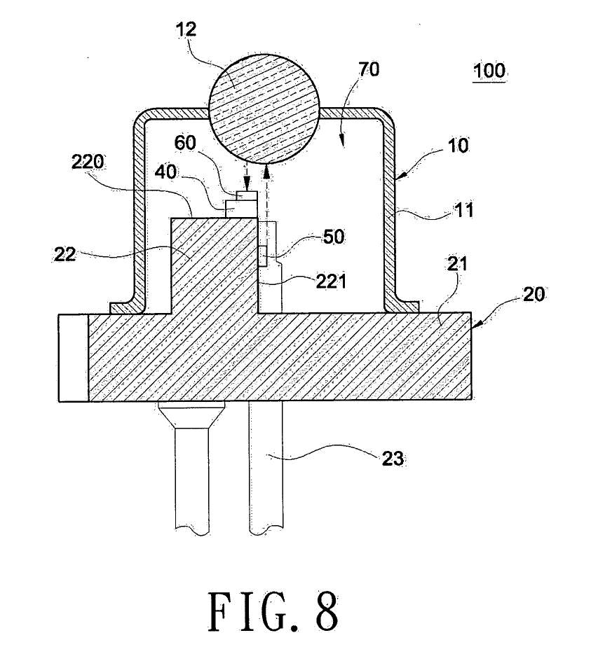

Referring to FIG. 7, a sub-mount 30 is disposed between the side assembling surface 221 of the post 22 and the laser chip 50 so as to adjust the position of the laser chip 50 relative to the lens 12. Referring to FIG. 8, alternatively, a sub-mount 40 is disposed between the top assembling surface 220 of the post 22 and the light-receiving chip 60 so as to adjust the position of the light-receiving chip 60 relative to the lens 12.

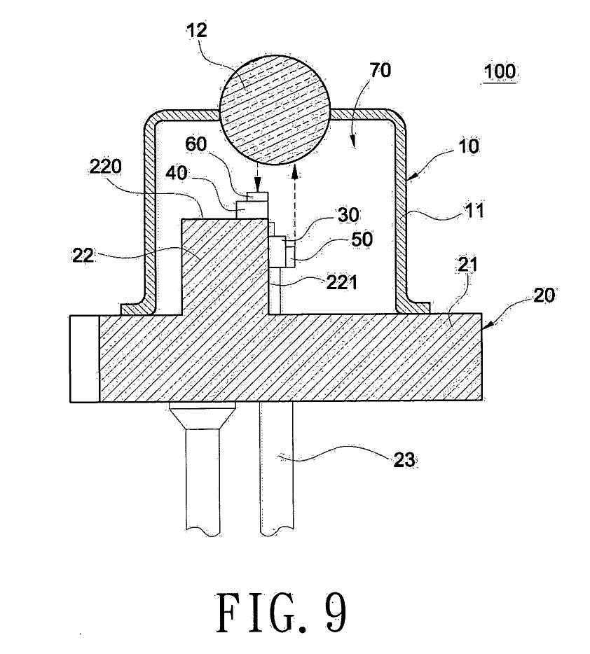

Referring to FIG. 9, a sub-mount 30 is disposed between the side assembling surface 221 of the post 22 and the laser chip 50 so as to adjust the position of the laser chip 50 relative to the lens 12, and a sub-mount 40 is disposed between the top assembling surface 220 of the post 22 and the light-receiving chip 60 so as to adjust the position of the light-receiving chip 60 relative to the lens 12, with a view to enhancing optical performance. The sub-mounts 30, 40 are made of an insulating material or an electrically conductive material.

In short, according to the present invention, the laser chip 50 and light-receiving chip 60 are together provided within a TO-can package so as to effectuate a bi-directional optical device for emitting and receiving light of different wavelengths. The bi-directional optical device of the present invention only need to be assembled with another light-receiving device in TO-can package or another laser device in TO-can package to form a receiver optical subassembly (ROSA) or a transmitter optical subassembly (TOSA) essential to triple-wavelength bi-directional transmission. Having only two TO-can packaged components, the resultant ROSA or TOSA has a simple structure and incurs low costs of parts as well as of assembly, thereby achieving the effect of the present invention.

The present invention has been described with preferred embodiments thereof, and it is understood that many changes and modifications to the described embodiment can be carried out without departing from the scope and the spirit of the invention that is intended to be limited only by the appended claims.

What is claimed is:

1. A bi-directional optical device for use in fiber-optic communications, comprising:
a TO cap having a cap body and a lens mounted on the cap body;
a TO header defining a receiving space together with the TO cap;
a laser chip provided on the TO header and in the receiving space and configured to emit a first laser beam toward the lens; and
a light-receiving chip provided on the TO header and in the receiving space, facing the lens, and configured to receive a second laser beam transmitted through the lens.

2. The bi-directional optical device of claim 1, wherein the light-receiving chip is either an APD diode light-receiving chip, a PIN diode light-receiving chip or a side-illumination photo diode chip made of a semiconductor material.

3. The bi-directional optical device of claim 1, wherein the laser chip is either a surface-emitting laser or an edge-emitting laser made of a semiconductor material.

4. The bi-directional optical device of claim 1, further comprising a sub-mount; wherein, the sub-mount is disposed either between a bottom board of the TO header and the light-receiving chip or between the bottom board of the TO header and the laser chip.

5. The bi-directional optical device of claim 4, wherein the sub-mount is made of either an insulating material or an electrically conductive material.

6. The bi-directional optical device of claim 1, further comprising two sub-mounts disposed between a bottom board of the TO header and the light-receiving chip and between the bottom board of the TO header and the laser chip, respectively.

7. The bi-directional optical device of claim 6, wherein the sub-mounts are made of either an insulating material or an electrically conductive material.

8. The bi-directional optical device of claim 1, wherein the TO header is provided with a bottom board and a post extending from the bottom board into the receiving space, the post having a top assembling surface and a side assembling surface adjacent to the top assembling surface so that the laser chip and light-receiving chip are mounted on the side assembling surface and the top assembling surface, respectively.

9. The bi-directional optical device of claim 8, wherein the laser chip is a side-emitting laser made of a semiconductor material.

10. The bi-directional optical device of claim 8, further comprising a sub-mount; wherein, the sub-mount is disposed either between the top assembling surface and the light-receiving chip or between the side assembling surface and the laser chip.

11. The bi-directional optical device of claim 10, wherein the sub-mount is made of either an insulating material or an electrically conductive material.

12. The bi-directional optical device of claim 8, further comprising two sub-mounts disposed between the top assembling surface and the light-receiving chip and between the side assembling surface and the laser chip, respectively.

13. The bi-directional optical device of claim 12, wherein the sub-mounts are made of either an insulating material or an electrically conductive material.
